(19) United States
(12) Patent Application Publication
(10) Pub. No.: US 2024/0386073 A1
(43) Pub. Date: Nov. 21, 2024

(54) FEATURE FUSION WITH MEASUREMENT UNCERTAINTY

(71) Applicant: Raytheon Company, Waltham, MA (US)

(72) Inventors: Adam Hodge Greenberg, GARDENA, CA (US); Bradley A. Flanders, Whittier, CA (US)

(21) Appl. No.: 18/198,645

(22) Filed: May 17, 2023

(51) Int. Cl. G06F 17/18

(52) U.S. Cl. CPC G06F 17/18

(57) ABSTRACT

Embodiments regard feature fusion with uncertainty, such as for classification. A method includes altering, for each feature of features to be fused and based on a marginal uncertainty distribution corresponding to a feature of the features and the marginal uncertainty distribution accounting for uncertainty in measuring the feature, a marginal feature distribution of the feature resulting in respective marginal feature distributions that account for uncertainty, altering, based on a joint uncertainty covariance of the features, a joint feature covariance of the features resulting in a covariance that jointly accounts for feature covariance and uncertainty covariance, generating, based on the covariance that jointly accounts for feature covariance and uncertainty covariance and the respective marginal feature distributions that account for uncertainty, a joint density function that accounts for feature values and uncertainty, and classifying the features based on the joint density function that accounts for feature values and uncertainty.

### TECHNICAL FIELD

Embodiments provide for efficient feature fusion with uncertainty preservation through the fusion. Embodiments have many applications including any application in which a probability density of multiple features with corresponding uncertainties is desired.

### BACKGROUND

Modern classification systems include assessment of features from multiple sensors and phenomenological sources. Often, these features are correlated. These correlated features are thus used concurrently. Currently, fusion of N features is performed in an N-dimensional space. Operating in N dimensional space is computationally cumbersome or infeasible, especially for larger N and even for N greater than three. Current techniques for operating in N dimensional space use convolution. Convolution is prohibitively expensive in terms of compute cost and time.

### BRIEF DESCRIPTION OF THE DRAWINGS

FIG. 1 illustrates, by way of example, a diagram of an embodiment of a conceptual diagram of generating a probability density function (PDF) that reflects value and corresponding uncertainty in fused features.

FIG. 2 illustrates, by way of example, a flow diagram of an embodiment of an operation for determining marginal measurement distributions.

FIG. 3 illustrates, by way of example, a flow diagram of an embodiment of an operation for determining marginal uncertainty distributions.

FIG. 4 illustrates, by way of example, a diagram of an embodiment of generating marginal measurement and uncertainty distributions based on marginal measurement distributions from operations of FIG. 2 and marginal uncertainty distributions from operations of FIG. 3.

FIG. 5 illustrates, by way of example, a diagram of an embodiment of generating a joint distribution based on marginal measurement and uncertainty distributions and the covariance of measurements that accounts for uncertainty.

FIG. 6 illustrates, by way of example, a diagram of an embodiment of a method for feature fusion.

FIG. 7 illustrates, by way of example, a block diagram of an embodiment of a machine in the example form of a computer system within which instructions, for causing the machine to perform any one or more of the methods discussed herein, may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments operate by determining or accessing a covariance matrix, population feature distributions, and a feature measurement uncertainty distribution. The covariance matrix indicates respective correlation strengths between features in the feature distribution. A first feature (e.g., a characteristic that can be measured or estimated) that is strongly correlated with a second feature means that knowledge of the value of the first feature is strongly indicative of the value of the second feature. A first feature that is weakly correlated with a second feature means that the knowledge of the value of the first feature is not predictive of the value of the second feature.

The population feature distributions are respective sets of possible values for a given feature along with a measure of relative likelihood (relative to all other feature values of the same feature distribution) for all possible feature values (whether all previously seen feature values or based on operating conditions or operating parameters of a transducer or transducers that made the features). The feature measurement uncertainty distribution indicates an amount of uncertainty in a measurement or measurements of a possible combination of feature values. Each combination of feature values includes a specific feature value from each of the feature distributions. Thus, if there are N features, the uncertainty distribution is N-dimensional. Each of the population feature distributions, in contrast, are marginal distributions. The covariance matrix is an N×N matrix.

Embodiments operate by determining, for each point in a population feature marginal distribution, a weighted average of neighboring points. The weights correspond to values from the measurement uncertainty (which can account for feature measurement error) distribution. The weights are applied to neighboring points in the population feature marginal distribution relative to a point of interest. The resulting population feature marginal distributions reflect uncertainty in the population feature distributions. The resulting population feature marginal distributions are sometimes called marginal feature distributions.

A covariance matrix of the population feature marginal distributions is updated to reflect covariance of the corresponding measurement uncertainties. Covariance matrices can be combined using simple addition. The resulting covariance matrix is sometimes called a feature and uncertainty covariance matrix.

A probability density function (PDF) is then determined based on the feature and uncertainty covariance matrix and each of the population feature marginal and measurement uncertainty distributions. The PDF can be determined using one of a variety of copulas. The result is a joint PDF of features (measurements) that reflects a corresponding uncertainty in each of the points of the PDF.

Embodiments improve processing over traditional convolution techniques of combining feature distributions and a corresponding uncertainty distribution. Performing the convolution techniques consumes computer processing on the order of O(k^{N}), where k is the number of samples in feature distributions and N is the number of features (i.e. the number of feature marginal distributions). Note that not all distributions need to be same size or have the same number of features. Currently, there are no known techniques for efficiently performing higher-dimensional convolutions.

Embodiments improve on this complexity to be on the order of O(kN). Rather than performing a strict convolution in N-dimensions as in prior solutions, determine weighted averages of neighboring points in one dimension.

Uncertainty affects a feature measurement or estimation in some interesting, and even counter-intuitive ways. For example, a binary classifier that operates based on two features can determine, without considering uncertainty of the features, a first result, but after considering uncertainty of the features switch its classification. In another example, the binary classifier may be more certain about its classification after considering uncertainty (e.g., by correctly accounting for feature uncertainty, the most certain classification result of the classifier may become even more certain). In general, failure to account for measurement uncertainty can result in unbounded errors on the classifiers output classification result, as well as on the probability assigned to that result.

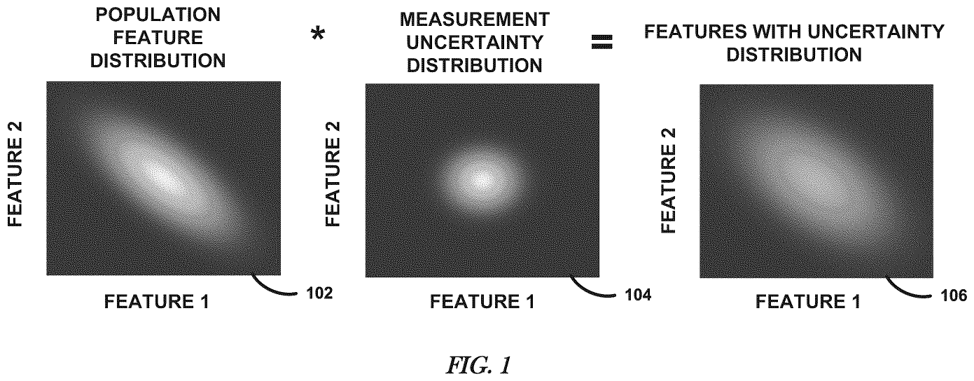

FIG. 1 illustrates, by way of example, a diagram of an embodiment of a conceptual diagram of generating a probability density function (PDF) that reflects value and corresponding uncertainty in fused features. Previously, a population feature distribution 102 was generated and combined with a measurement uncertainty distribution 104 via a convolution operation to generate a combined feature and uncertainty distribution 106. The complexity of generating the feature and uncertainty distribution 106 using an N features with k samples of each of the features is O(k^{N}). N and k and both positive integers. For even relatively small N, the complexity of performing such a convolution is quite high. For example, if N and k are both ten (10), the complexity of determining the convolution is 10¹⁰. Embodiments avoid the complexity of convolution-based techniques by determining weighted averages of neighboring points based on marginal distributions of features and marginal distributions of uncertainty. This change in feature fusion changes the complexity to O(kN). Using the example of N and k both being ten (10), an improvement in processing complexity of 10⁸ is realized over the prior N-dimensional convolution techniques.

The population feature distribution 102 is generated by collecting feature samples for each of a plurality of features and then combining marginal distributions for each of the features. Features are measurable parameters or characteristics of a region or object of interest. Features of a dog, for example, include fur color, eye color, fur length, weight, length, height, width, tail length, snout length, or the like. Features of a cat are similar to the features of a dog. Features of an aircraft include fuselage size (e.g., height, width, length), cockpit size, propeller type, landing gear location, engine type, engine location, wing shape, tail shape, or the like. Features of a land vehicle include size, number of doors, location of doors, engine size, engine location, number of axels, number of wheels, bed or no bed, bed size, or the like. Features of weather include precipitation, temperature, humidity, pressure, wind speed, wind direction, or the like. As can be seen, there are a wide variety of features, more than can be listed here. The features are a function of a goal of classification. The features are measurable aspects of an object or area that is subject to classification.

Often, the joint distribution of population features is unknown and difficult to measure, as such measurements can require the simultaneous operation of multiple different feature estimators or sensors. However, the corresponding marginal distributions may often be known, as these distributions do not require simultaneous operations. Furthermore, the covariance between feature populations may also be known or estimated. When the marginal distributions and covariances are known, then the full joint distribution can be approximated (for example through use of a copula).

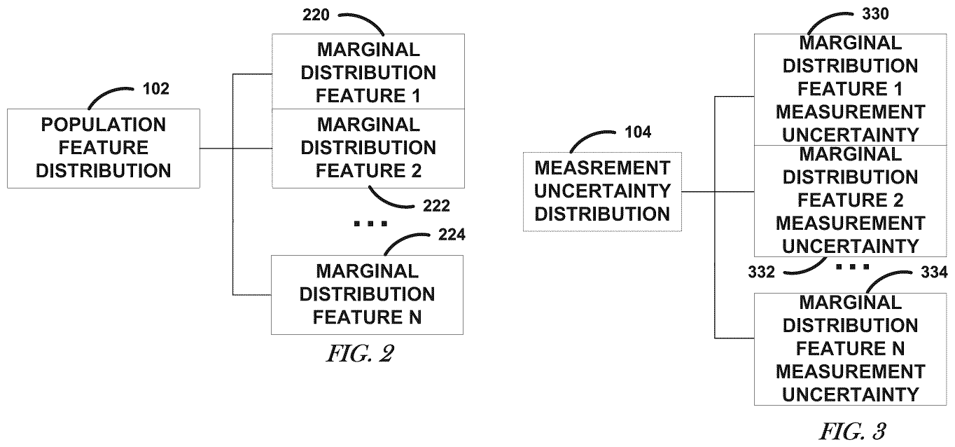

FIGS. 2-5 illustrate, by way of example, diagrams of respective operations for feature fusion. If the joint population feature distribution 102 is known, the operations of FIG. 2 can be used to generate marginal distributions 220, 222, 224. In some instances, the marginal distributions 220, 222, 224 may be readily available.

FIG. 2 illustrates, by way of example, a flow diagram of an embodiment of an operation for determining marginal feature distributions 220, 222, 224. Each of the marginal feature distributions 220, 222, 224 indicates the probability of each result of a respective feature used to generate the population feature distribution 102. The marginal feature distributions 220, 222, 224 can be determined using normal probability operations.

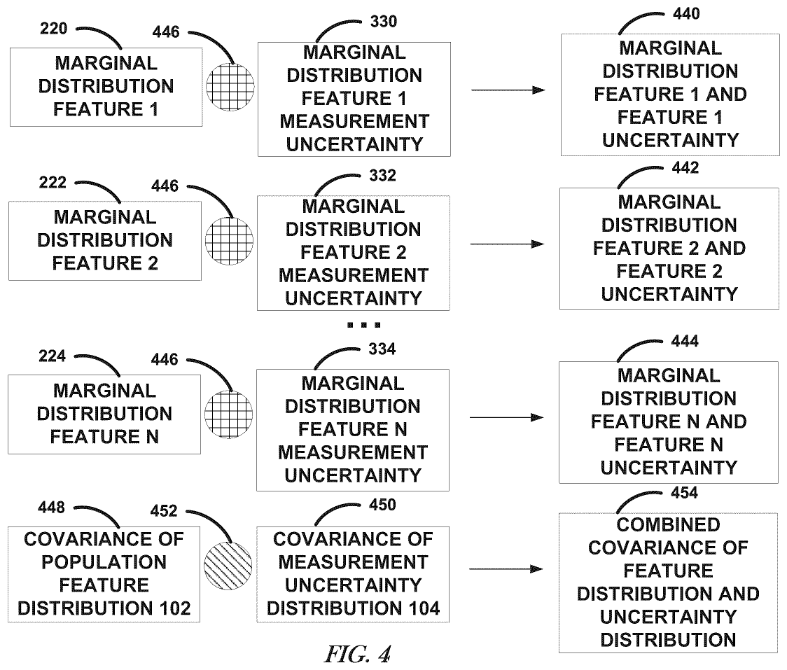

FIG. 3 illustrates, by way of example, a flow diagram of an embodiment of an operation for determining marginal feature measurement uncertainty distributions 330, 332, 334. Each of the marginal feature measurement uncertainty distributions 330, 332, 334 indicates the probability of each respective uncertainty result used to generate the uncertainty distribution 104. The marginal feature measurement uncertainty distributions 330, 332, 334 can be determined using normal probability operations.

With two random variables, X∈S and Y∈T, that have a joint probability distribution, which is a probability measure on S×T given by P[(X,Y)∈C] for C⊆S×T. The marginal distribution of X is the probability measure on S given by P(X∈A) for A⊆S. The distribution of Y is the probability measure on T given by P(Y∈B) for B⊆T. In this context, the distribution of (X,Y) is called the joint distribution, while the distributions of X and of Y are referred to as marginal distributions. The marginal distributions can be obtained from the joint distribution. Note that P(X∈A)=P[(X,Y)∈A∈T] for A⊆S P(Y⊆B)=P[(X,Y)∈S×B] for B⊆T.

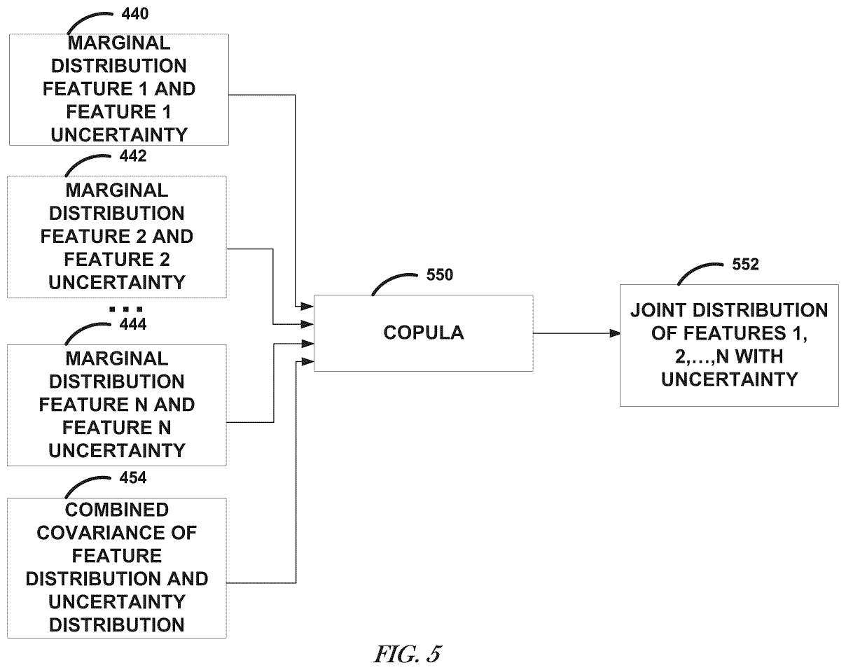

FIG. 4 illustrates, by way of example, a diagram of an embodiment of generating marginal feature and uncertainty distributions 440, 442, 444 based on marginal feature distributions 220, 222, 224 from operations of FIG. 2 and marginal feature measurement uncertainty distributions 330, 332, 334 from operations of FIG. 3. Generating the marginal feature and uncertainty distributions 440, 442, 444 can be determined by performing operation 446 at each point in each marginal feature distribution 220, 222, 224. The operation 446 determines, for each point in, for example, the marginal feature distribution 220, a weighted average of points in a neighborhood of the given point. The neighborhood can include a static or variable size. The size can be determined based on a heuristic or user-configurable. An example neighborhood size is a positive integer. The weights for each of the points in the neighborhood are the corresponding entries in the marginal uncertainty distribution 330, 332, 334. Thus, if the neighborhood size is four (4), the marginal feature distribution for a fifth feature value (m5) that considers uncertainty is (assuming ten possible sample values) [m1, m2, m3, m4, m5, m6, m7, m8, m9, m10] and the marginal uncertainty distribution is (again assuming ten possible sample values) [e1, e2, e3, e4, e5, e6. e7, e8, e9, e10] is sum (m5*e5+m4*e4+m3*e3+m6*e6+m7*e7)/5. These weighted summing operations are simple as compared to the convolution solutions of prior fusion techniques.

The operations of FIG. 4 also include determining a covariance of features that accounts for uncertainty 454. The covariance of features that accounts for uncertainty 454 can be determined based on a covariance 448 of the feature distribution 102 and a covariance 450 of the uncertainty distribution 104. An operation 452 can include combining the covariances 448, 450, such as by addition, to generate the covariance of features that accounts for uncertainty 454.

FIG. 5 illustrates, by way of example, a diagram of an embodiment of generating a joint distribution 552 based on marginal feature and measurement uncertainty distributions 440, 442, 444, and the covariance of features that accounts for measurement uncertainty 454. The operation of FIG. 5 includes using a copula 550 to generate the joint distribution 552 that accounts for feature measurement uncertainty. The copula 550 operates to generate a joint distribution 552 based on the marginal distributions 440, 442, 444 of the features and uncertainties and the covariance of features that accounts for measurement uncertainty 454. The resulting joint distribution has marginal distributions that are equal to the given input marginal distributions.

Assume the following notation, covariance matrix, Σ, marginal distribution 440, F₁(x₁), marginal distribution 442, F₂(x₂), marginal distribution 444, F_{N}(x_{N}). The Gaussian copula, which is merely an example copula, operates to generate joint distribution as

$${J}_{\{ F \} , \sum } ( \begin{matrix}{x}_{1} \\ {x}_{2} \\ … \\ {x}_{N}\end{matrix} ) = {Φ}_{\sum } ( \begin{matrix}{x}_{1}^{′} = {Φ}_{1}^{- 1} ( {F}_{1} ( {x}_{1} ) ) \\ {x}_{2}^{′} = {Φ}_{1}^{- 1} ( {F}_{2} ( {x}_{2} ) ) \\ … \\ {x}_{N}^{′} = {Φ}_{1}^{- 1} ( {F}_{N} ( {x}_{N} ) )\end{matrix} )$$

Where Φ_{Σ} is the multi-variate normal with covariance Σ and origin mean. Φ₁⁻¹ is the inverse of the standard normal distribution with unit variance.

There are many types of copulas and many joint distributions that can be generated and still have precise marginal distributions. The copulas can operate using distributions that are Gaussian, uniform, random, chi-squared, beta, exponential, Gamma, log normal, logistic, or the like in nature.

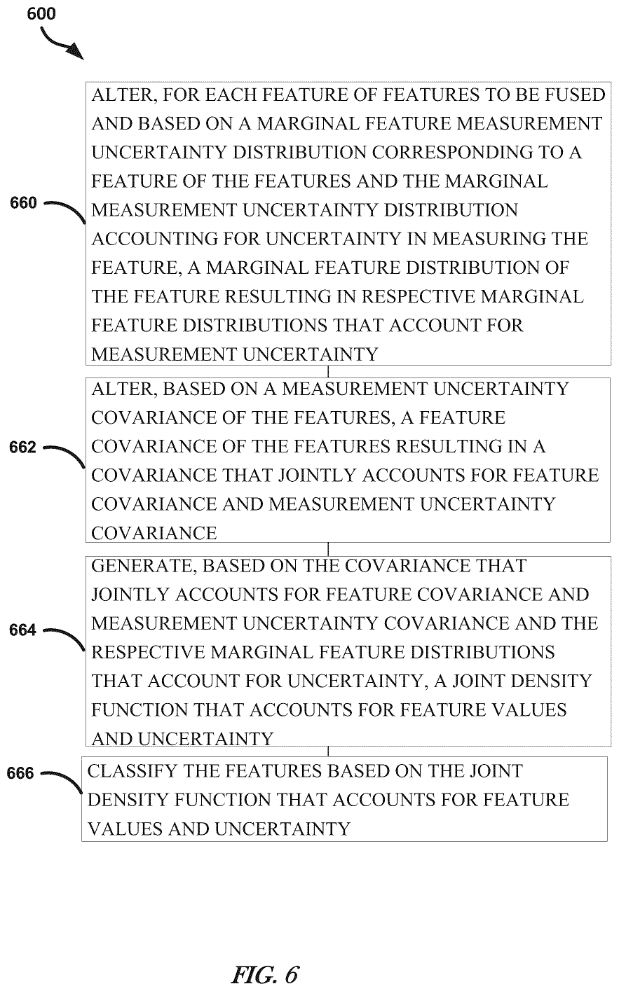

FIG. 6 illustrates, by way of example, a diagram of an embodiment of a method 600 for feature fusion with uncertainty. The method 600 as illustrated includes altering, for each feature of features of a population to be fused and based on a marginal measurement uncertainty distribution corresponding to a feature of the features and the marginal measurement uncertainty distribution accounting for uncertainty in measuring the feature, a marginal feature distribution of the feature resulting in respective marginal feature distributions that account for measurement uncertainty, at operation 660; altering, based on a measurement uncertainty covariance of the features, a feature covariance of the features resulting in a covariance that jointly accounts for feature covariance and measurement uncertainty covariance, at operation 662; generating, based on the covariance that jointly accounts for feature covariance and measurement uncertainty covariance and the respective marginal feature distributions that account for measurement uncertainty, a joint density function that accounts for feature values and uncertainty, at operation 664; and classifying the features based on the joint density function that accounts for feature values and measurement uncertainty, at operation 666.

The operation 660 can include determining, for each point of points in the marginal feature distribution, a weighted sum. The weights of the weighted sum can be uncertainty values in the marginal measurement uncertainty distribution. The weights can be constrained to a neighborhood of a corresponding point of the points.

The operation 664 can be performed using a copula. The marginal measurement uncertainty distribution can be Gaussian. The operation 666 can include classifying as part of an automatic target recognition (ATR) operation. The marginal measurement uncertainty distributions and marginal feature distributions can be one-dimensional.

Embodiments provide for computationally efficient feature fusion that is capable of operating efficiently in higher dimensional spaces than prior solutions. This is because the increase in complexity of embodiments is linear with increase in number of features. Embodiments account for feature uncertainty in an efficient manner. Embodiments enable performing classification using a copula-based distribution in a computationally efficient manner. Further, precise (rather than ad hoc) accounting for feature uncertainty reduces the time spent on root cause analysis for classification failure, saving time and cost.

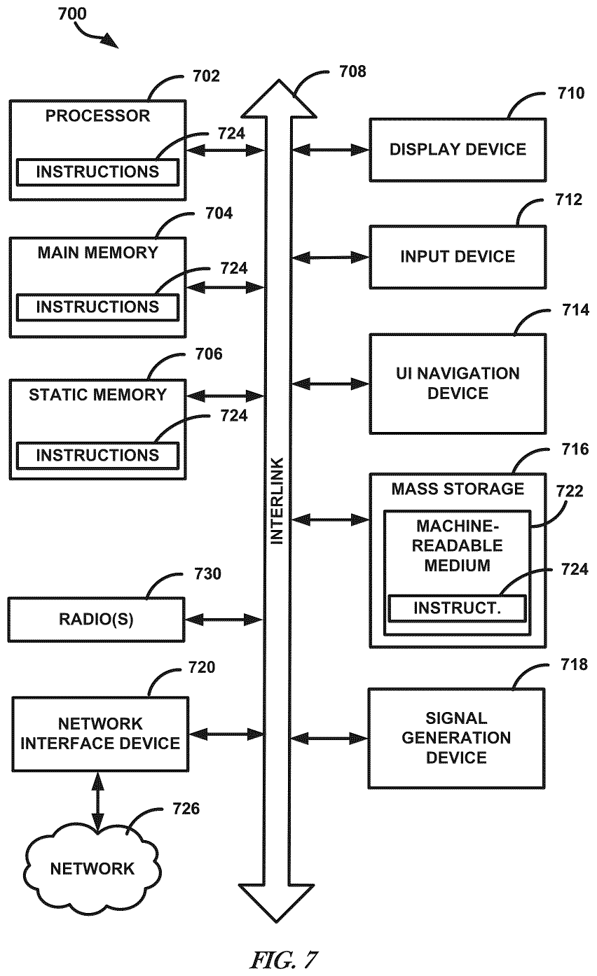

FIG. 7 illustrates, by way of example, a block diagram of an embodiment of a machine in the example form of a computer system 700 within which instructions, for causing the machine to perform any one or more of the methods discussed herein, may be executed. One or more of the operations of FIG. 2-5 or the operations of the method 600, can include, or be implemented or performed by one or more of the components of the computer system 700. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a mass storage unit 716, a signal generation device 718 (e.g., a speaker), a network interface device 720, and a radio 730 such as Bluetooth, WWAN, WLAN, and NFC, permitting the application of security controls on such protocols.

The mass storage unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Notes and Examples

Example 1 includes a method comprising altering, for each feature of features to be fused and based on a marginal uncertainty distribution corresponding to a feature of the features and the marginal uncertainty distribution accounting for uncertainty in measuring the feature, a marginal feature distribution of the feature resulting in respective marginal feature distributions that account for uncertainty, altering, based on a joint uncertainty covariance of the features, a joint feature covariance of the features resulting in a covariance that jointly accounts for feature covariance and uncertainty covariance, generating, based on the covariance that jointly accounts for feature covariance and uncertainty covariance and the respective marginal feature distributions that account for uncertainty, a joint density function that accounts for feature values and uncertainty, and classifying the features based on the joint density function that accounts for feature values and uncertainty.

In Example 2, Example 1 further includes, wherein altering the marginal feature distribution includes determining, for each point of points in the marginal feature distribution, a weighted sum.

In Example 3, Example 2 further includes, wherein weights of the weighted sum are uncertainty values in the marginal uncertainty distribution.

In Example 4, Example 3 further includes, wherein the weights are constrained to a neighborhood of a corresponding point of the points.

In Example 5, at least one of Examples 1-4 further includes, wherein generating the joint density function that accounts for feature values and uncertainty includes using a copula.

In Example 6, at least one of Examples 1-5 further includes, wherein the marginal uncertainty distribution is Gaussian.

In Example 7, at least one of Examples 1-6 further includes, wherein classifying includes classifying as part of an automatic target recognition (ATR) operation.

In Example 8, at least one of Examples 1-7 further includes, wherein the marginal uncertainty distributions and marginal feature distributions are one-dimensional.

Example 9 includes a non-transitory machine-readable medium including instructions that, when executed by a machine, cause the machine to perform the method of one of Examples 1-8.

Example 10 includes a system comprising processing circuitry, and a memory including instructions that, when executed by the processing circuitry, cause the processing circuitry to perform operations comprising the method of one of Examples 1-8.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
altering, for each feature of features of a population to be fused and based on a marginal measurement uncertainty distribution corresponding to a feature of the features and the marginal measurement uncertainty distribution accounting for uncertainty in measuring the feature, a marginal feature distribution of the feature resulting in respective marginal feature distributions that account for measurement uncertainty;
altering, based on a measurement uncertainty covariance of the features, a feature covariance of the features resulting in a covariance that jointly accounts for feature covariance and measurement uncertainty covariance;
generating, based on the covariance that jointly accounts for feature covariance and measurement uncertainty covariance and the respective marginal feature distributions that account for measurement uncertainty, a joint density function that accounts for feature and measurement uncertainty; and
classifying feature values of the features based on the joint density function that accounts for feature and measurement uncertainty.

2. The method of claim 1, wherein altering the marginal feature distribution includes determining, for each point of points in the marginal feature distribution, a weighted sum.

3. The method of claim 2, wherein weights of the weighted sum are measurement uncertainty values in the marginal measurement uncertainty distribution.

4. The method of claim 3, wherein the weights are constrained to a neighborhood of a corresponding point of the points.

5. The method of claim 1, wherein generating the joint density function that accounts for feature values and measurement uncertainty includes using a copula.

6. The method of claim 1, wherein the marginal measurement uncertainty distribution is Gaussian.

7. The method of claim 1, wherein classifying includes classifying as part of an automatic target recognition (ATR) operation.

8. The method of claim 1, wherein the marginal measurement uncertainty distributions and marginal feature distributions are one-dimensional.

9. A system for feature fusion with uncertainty, the system comprising:
processing circuitry;
a memory including instructions that, when executed by the processing circuitry, causes the processing circuitry to perform operations comprising:
altering, for each feature of features of a population to be fused and based on a marginal measurement uncertainty distribution corresponding to a feature of the features and the marginal measurement uncertainty distribution accounting for uncertainty in measuring the feature, a marginal feature distribution of the feature resulting in respective marginal feature distributions that account for measurement uncertainty;
altering, based on a measurement uncertainty covariance of the features, a feature covariance of the features resulting in a covariance that jointly accounts for feature covariance and measurement uncertainty covariance;
generating, based on the covariance that jointly accounts for feature covariance and measurement uncertainty covariance and the respective marginal feature distributions that account for measurement uncertainty, a joint density function that accounts for feature and measurement uncertainty; and
classifying feature values based on the joint density function that accounts for feature and measurement uncertainty.

10. The system of claim 9, wherein altering the marginal feature distribution includes determining, for each point of points in the marginal feature distribution, a weighted sum.

11. The system of claim 10, wherein weights of the weighted sum are measurement uncertainty values in the marginal measurement uncertainty distribution.

12. The system of claim 11, wherein the weights are constrained to a neighborhood of a corresponding point of the points.

13. The system of claim 9, wherein generating the joint density function that accounts for feature values and uncertainty includes using a copula.

14. The system of claim 9, wherein the marginal measurement uncertainty distribution is Gaussian.

15. The system of claim 9, wherein classifying includes classifying as part of an automatic target recognition (ATR) operation.

16. The system of claim 9, wherein the marginal measurement uncertainty distributions and marginal feature distributions are one-dimensional.

17. A non-transitory machine readable medium including instructions that, when executed by a machine, cause the machine to perform operations comprising:
altering, for each feature of features of a population to be fused and based on a marginal measurement uncertainty distribution corresponding to a feature of the features and the marginal measurement uncertainty distribution accounting for measurement uncertainty in measuring the feature, a marginal feature distribution of the feature resulting in respective marginal feature distributions that account for measurement uncertainty;
altering, based on a measurement uncertainty covariance of the features, a feature covariance of the features resulting in a covariance that jointly accounts for feature covariance and measurement uncertainty covariance;
generating, based on the covariance that jointly accounts for feature covariance and measurement uncertainty covariance and the respective marginal feature distributions that account for measurement uncertainty, a joint density function that accounts for feature and measurement uncertainty; and
classifying feature values based on the joint density function that accounts for feature and measurement uncertainty.

18. The non-transitory machine-readable medium of claim 17, wherein altering the marginal feature distribution includes determining, for each point of points in the marginal feature distribution, a weighted sum.

19. The non-transitory machine-readable medium of claim 18, wherein weights of the weighted sum are uncertainty values in the marginal measurement uncertainty distribution.

20. The non-transitory machine-readable medium of claim 19, wherein the weights are constrained to a neighborhood of a corresponding point of the points.
